(19) United States
(12) Patent Application Publication
(10) Pub. No.: US 2025/0341898 A1
(43) Pub. Date: Nov. 6, 2025

(54) HAND BASED USER INTERFACE FOR MIXED REALITY

(71) Applicant: Sony Interactive Entertainment Inc., Tokyo (JP)

(72) Inventor: Joohyun Bae, San Mateo, CA (US)

(21) Appl. No.: 18/656,165

(22) Filed: May 6, 2024

(51) Int. Cl. G06F 3/01; G02B 27/01; G06F 3/04847; G06F 3/0485; G06V 40/10; G06V 40/20

(52) U.S. Cl. CPC G06F 3/017; G02B 27/0101; G02B 27/017; G06F 3/011; G06F 3/04847; G06F 3/0485; G06V 40/10; G06V 40/28; G02B 2027/0138; G02B 2027/014

(57) ABSTRACT

A method for providing a user interface through a head-mounted display worn by a user is provided, including: identifying and tracking a hand of the user, including identifying and tracking a thumb and a fingertip of the hand of the user; providing a real-time view of the user's hand through the head-mounted display; rendering a graphical user interface (UI) element in association with a fingertip of the user's hand in the real-time view of the hand through the head-mounted display; wherein detection of touching of the thumb to the fingertip activates selection of the graphical UI element to trigger an action associated with the graphical UI element.

### BACKGROUND OF THE INVENTION

While augmented reality (AR), mixed reality (XR), and virtual reality (VR) technologies facilitate immersive and intuitive experiences, designing effective user interfaces in these contexts is challenging. Modern user interface (UI) and user experience (UX) design has tended to optimize for touchscreens with the mass adoption of smartphones, tablets and other form factors embodying touchscreen interfaces (e.g. automotive displays, etc.). However, in AR/XR/VR contexts, there is no inherent touchscreen for the user to interact with, and thus importing such interfaces into an AR/XR/VR context is suboptimal while also failing to leverage the capabilities of the AR/XR/VR technologies. Hence, this presents a challenge as to how to provide a user interface for AR/XR/VR contexts that is intuitive and effective for the user in such immersive contexts.

It is in this context that implementations of the disclosure arise.

### SUMMARY OF THE INVENTION

Implementations of the present disclosure include methods, systems and devices for providing a hand-based user interface for mixed reality, augmented reality, and virtual reality experiences.

In some implementations, a method for providing a user interface through a head-mounted display worn by a user is provided, including: identifying and tracking a hand of the user, including identifying and tracking a thumb and a fingertip of the hand of the user; providing a real-time view of the user's hand through the head-mounted display; rendering a graphical user interface (UI) element in association with a fingertip of the user's hand in the real-time view of the hand through the head-mounted display; wherein detection of touching of the thumb to the fingertip activates selection of the graphical UI element to trigger an action associated with the graphical UI element.

In some implementations, the graphical UI element is rendered as an overlay on the fingertip of the user's hand.

In some implementations, the rendering of the graphical UI element is configured to track movements of the fingertip to maintain positioning of the graphical UI element in association with the fingertip.

In some implementations, rendering the graphical UI element is in response to detecting viewing by the user of the hand.

In some implementations, rendering the graphical UI element is in response to detecting the user's hand in an open-hand pose with a palm side of the hand facing the user.

In some implementations, identifying and tracking the user's hand includes capturing images of the user's hand by a camera integrated with the head-mounted display.

In some implementations, activating selection of the graphical UI element triggers rendering of a graphical slider element configured to enable adjustment of a setting by the thumb of the user's hand.

In some implementations, a method for providing a user interface through a head-mounted display worn by a user is provided, including: identifying and tracking a hand of the user, including identifying and tracking a thumb and fingertips of the hand of the user; providing a real-time view of the user's hand through the head-mounted display; rendering a plurality of graphical user interface (UI) elements in respective association with the fingertips of the user's hand in the real-time view of the hand through the head-mounted display; wherein detection of touching of the thumb to a given fingertip activates selection of the graphical UI element associated with the given fingertip to trigger an action associated with the graphical UI element.

In some implementations, the plurality of graphical UI elements are rendered as overlays on the respective fingertips of the user's hand.

In some implementations, the rendering of the graphical UI elements is configured to track movements of the fingertips to maintain positioning of the graphical UI elements in respective association with the fingertips.

In some implementations, rendering the graphical UI elements is in response to detecting viewing by the user of the hand.

In some implementations, rendering the graphical UI elements is in response to detecting the user's hand in an open-hand pose with a palm side of the hand facing the user.

In some implementations, identifying and tracking the user's hand includes capturing images of the user's hand by a camera integrated with the head-mounted display.

In some implementations, detection of swiping of the thumb across fingers of the user's hand triggers scrolling of the graphical UI elements.

In some implementations, a non-transitory computer-readable medium is provided having program instructions embodied thereon that, when executed by at least one computing device, cause said at least one computing device to perform a method for providing a user interface through a head-mounted display worn by a user, said method including: identifying and tracking a hand of the user, including identifying and tracking a thumb and a fingertip of the hand of the user; providing a real-time view of the user's hand through the head-mounted display; rendering a graphical user interface (UI) element in association with a fingertip of the user's hand in the real-time view of the hand through the head-mounted display; wherein detection of touching of the thumb to the fingertip activates selection of the graphical UI element to trigger an action associated with the graphical UI element.

Other aspects and advantages of the disclosure will become apparent from the following detailed description, taken in conjunction with the accompanying drawings, illustrating by way of example the principles of the disclosure.

### BRIEF DESCRIPTION OF DRAWINGS

The disclosure may be better understood by reference to the following description taken in conjunction with the accompanying drawings in which:

FIG. 1 conceptually illustrates a user 100 wearing a head-mounted display (HMD) 102, in accordance with implementation of the disclosure.

FIG. 2A illustrates a view of the user's hand having a user interface rendered in association therewith, in accordance with implementations of the disclosure.

FIG. 2B illustrates selection of a UI element, in accordance with implementations of the disclosure.

FIG. 3 illustrates a slider interface element, in accordance with implementations of the disclosure.

FIG. 4 illustrates a scrolling function operated by a user's hand gesture, in accordance with implementations of the disclosure.

FIG. 5 illustrates surfacing of additional information in response to a hand gesture, in accordance with implementations of the disclosure.

FIG. 6 illustrates components of an example device 600 that can be used to perform aspects of the various embodiments of the present disclosure.

### DETAILED DESCRIPTION OF THE INVENTION

Implementations of the present disclosure include methods, systems, and devices for providing a user interface (UI) for augmented reality (AR), mixed reality (XR), and virtual reality (VR) contexts. In some implementations, the user interface more specifically entails rendering UI elements such as selectable icons in association with a user's fingers. In some implementations, the selectable icons are rendered in the user's view through a head-mounted display when it is detected that the user is looking at their hand, or when the user's hand is detected in a predefined orientation. Thus, in one example, when the user is determined to be looking at the palm side of their hand, then the selectable icons are rendered in the user's view, with the selectable icons positioned as an overlay on the user's fingertips. In some implementations, a given selectable icon can be triggered by tapping or touching the thumb to the fingertip where the given selectable icon is positioned.

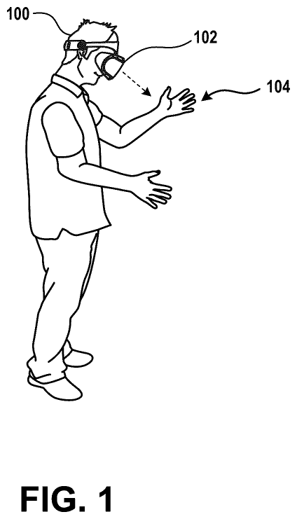

FIG. 1 conceptually illustrates a user 100 wearing a head-mounted display (HMD) 102, in accordance with implementation of the disclosure.

In various implementation's, the HMD 102 is configured to provide an augmented reality experience, a mixed reality experience, or a virtual reality experience. Generally, speaking, augmented reality refers to the overlay of information or objects onto a real-world view as seen by the user 100. Whereas mixed reality refers to the rendering of virtual objects in a real-world view so as to appear to be integrated with or interacting with the physical objects in the real-world environment, possibly in a manner that is substantially indistinguishable from the physical objects in the real-world environment. On the other hand, virtual reality refers to the immersion of the user in an entirely non-real virtual environment.

Accordingly, in some implementations, the HMD 102 includes a substantially transparent see-through display, which is generally suitable for providing AR and XR experiences. Whereas in other implementations, the HMD 102 includes a non-transparent display, which is generally suitable for providing a VR experience, but may also be used to provide an AR/XR experience by displaying a feed from an externally facing camera of the HMD in a manner that mimics the natural viewing of the local environment by the user that would otherwise occur absent the HMD's non-transparent display. In various implementations, the HMD 102 has the form factor of a headset, goggles, glasses, etc.

In some implementations, the HMD 102 is connected (wired or wirelessly, and/or over a network) to an external computing device (local or remote; not shown) such as a game console, personal computer, server computer, etc. which may be configured to render video for presentation through the HMD 102. In other implementations, the HMD 102 is a standalone device, having sufficient processing and memory resources, for rendering video that is presented through the HMD for viewing by the user 100. The HMD 102 can include various motion sensing hardware, such as accelerometers, gyroscopes, magnetometers, etc. In some implementations, the HMD 102 includes externally facing cameras, whose captured images are analyzed to enable determination and tracking of the HMD's position (including location and orientation) and movements. In some implementations, sensing devices placed in the local environment, such as separate cameras placed in the local environment, are utilized to track the HMD 102.

In some implementations, the HMD 102 is further configured to provide gaze tracking capability, such as by using internal facing cameras integrated with the HMD 102 to capture images of the user's eyes which are processed, along with the tracked movements of the HMD itself, to enable gaze tracking of the user 100. Further, by performing gaze tracking of the user 100, it is possible to determine where the user 100 is looking and what the user 100 is looking at. It will be appreciated that externally facing cameras of the HMD can be used to determine what is in the local environment, and based on the tracked gaze direction of the user 100, it is possible to determine what the user is looking at. More specifically, the user's hands can be recognized and tracked by analyzing captured images from the HMD's externally facing cameras. And accordingly, based on the user's gaze direction, it can be determined when the user is looking at their hands. For example, in the illustrated implementation, the gaze of the user 100 is tracked as the user 100 is looking at their hand 104.

As discussed in further detail below, a user interface is provided that is rendered in association with the user's hand. In some implementations, the rendering of the user interface is triggered when it is determined that the gaze of the user 100 is directed towards the user's hand 104, and/or the user's hand 104 is determined to have a predefined hand pose. In some implementations, the predefined hand pose can be one in which the palm side of the user's hand is facing the user 100 (such that the user 100 can see the palm of their hand 104), and the fingers of the hand 104 are extended. In some implementations, the predefined hand pose includes a movement, such as raising of the hand 104 towards the user's face/head. In some implementations, the predefined hand pose includes the hand 104 being positioned within a predefined distance of the user's face/head.

It will be appreciated that while implementations of the user interface are described with reference to an HMD supporting AR, XR, or VR contexts, in other implementations, the user interface embodiments of the present disclosure can be provided through other types of devices providing AR/XR/VR experiences, such as through a smartphone or tablet configured to provide an augmented reality experience.

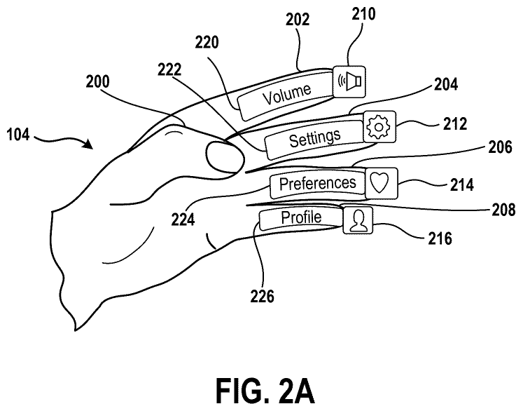

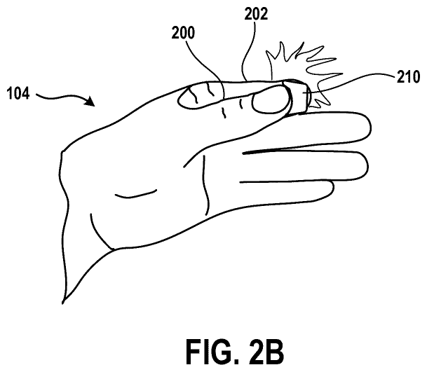

FIG. 2A illustrates a view of the user's hand having a user interface rendered in association therewith, in accordance with implementations of the disclosure.

In the illustrated implementation, a close-up view of the user's hand 104 is shown, as viewed in an AR/XR/VR context through an HMD or smartphone screen, for example. As shown, the user's hand 104 is oriented so that the palm side of the hand 104 is visible, and the digits of the user's hand 104 are shown including the thumb 200, index finger 202, middle finger 204, ring finger 206, and pinky finger 208. A user interface is presented in association with the user's hand 104 by rendering various UI elements in the view. More specifically, the UI elements include icons 210, 212, 214, and 216, and labels 220, 222, 224, and 226. As shown, the icons 210, 212, 214, and 216 are rendered so as to be positioned at, or proximate or mapped or attached to, the fingertips of the user's index, middle, ring, and pinky fingers, respectively. In some implementations, the icons 210, 212, 214, and 216 are rendered as overlays over their corresponding fingertips.

Labels 220, 222, 224, and 226 are provided which correspond to the icons 210, 212, 214, and 216, respectively. In some implementations, the labels provide descriptive information, names, or other information/data pertaining to the icons. In some implementations, as shown, the labels can be rendered along the lengths of the fingers adjacent to their corresponding icons. It will be appreciated that as the icons and labels are positioned at the fingertips and along the finger lengths, then as the user's hand is tracked, so the UI elements move with the movements of the hand to maintain their relationship to the user's hand. And in this manner, the user 100 can maneuver the UI elements by maneuvering their hand, for example, to a comfortable or otherwise preferred position for viewing and interacting with the user interface. Thus, the user interface is intuitively positioned (and automatically re-positioned according to the user's hand movements) without needing to access any special settings.

FIG. 2B illustrates selection of a UI element, in accordance with implementations of the disclosure.

In some implementations, the icons 210, 212, 214, and 216 are selectable by the user, and may function as virtual buttons that can be “pressed” when the user taps/touches their thumb (or another finger on their other hand) to the corresponding fingertip of a given button. For example, in the illustrated implementation the user is tapping their thumb 200 (on the same hand 104) to the fingertip of their index finger 202 where the icon 210 is rendered. Detection of this tapping is interpreted as selection of the icon 210 to activate some functionality associated with or otherwise accessible through the icon 210.

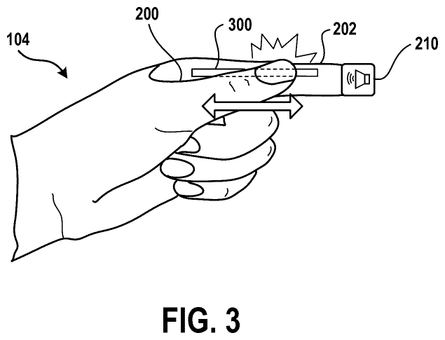

In some implementations, selection of the icon 210 triggers surfacing of another interactive UI element configured to enable adjustment of the function that is accessed through the icon 210. One example of another interactive UI element is shown with reference to FIG. 3.

FIG. 3 illustrates a slider interface element, in accordance with implementations of the disclosure.

In the illustrated implementation, a slider 300 is rendered along the length of the user's index finger 202. By sliding their thumb 200 along the slider 300 and index finger 202, the user is able to adjust a function controlled by the slider. For example, the icon 210 can be a volume button, and by selecting the volume button, then the slider 300 is surfaced in response as shown. And then by sliding their thumb 200 along their index finger 202, the user is able to adjust the volume up or down. In this manner, an intuitive mechanism is provided for adjustment of a function or setting such as volume.

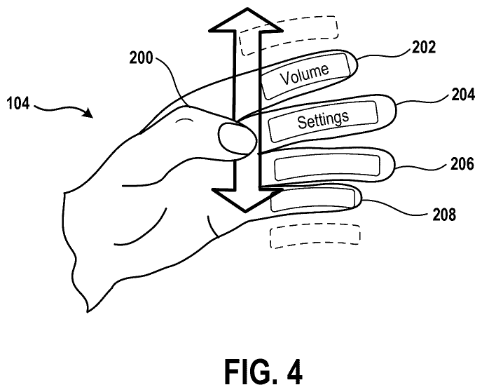

FIG. 4 illustrates a scrolling function operated by a user's hand gesture, in accordance with implementations of the disclosure.

In the illustrated implementation, the user is enabled to scroll a display of UI elements by swiping their thumb up and down across their fingers. For example, in some implementations, UI elements such as the labels and icons shown at FIG. 2A can be scrolled by swiping the thumb 200 up and down, to reveal additional labels and icons. The scrolling can be configured to automatically render labels/icons in a manner that “snaps to” the fingers/fingertips of the user's hand 104. For example, when the thumb 200 is detected swiping across the other fingers, then the thumb's position actively controls the scrolling positioning of the labels/icons, whereas when the thumb 200 is moved away from the other fingers, this releases the control of the scroll positioning and the labels/icons will snap to the fingers. In some implementations, scroll inertia can be provided so that the scrolling of the UI elements gradually slows to a stop and snaps to the fingers when the thumb is released.

In some implementations, additional UI elements that are accessible by scrolling can be at least partially shown, for example, above or below the UI elements that are currently active and rendered along the user's fingers. In some implementations, UI elements that are rendered along the fingers can be rendered with full opacity for visibility, whereas additional UI elements which may be scrolled onto the fingers for access, can be rendered in a semi-transparent or outline or other manner, so as to indicate their availability without fully obscuring other objects behind.

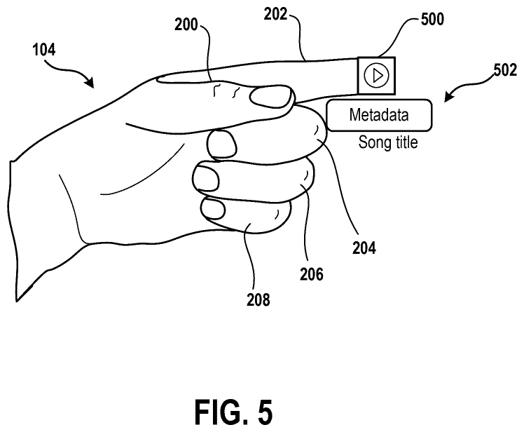

FIG. 5 illustrates surfacing of additional information in response to a hand gesture, in accordance with implementations of the disclosure.

In some implementations, curling of the fingers of the user's hand 104 can be configured to trigger surfacing of additional UI elements or information. For example, in the illustrated implementation the user's index finger 202 has a UI element 500 associated therewith. In some implementations, curling of the other fingers 204, 206 and 208 triggers rendering of additional information 502, for example, information related specifically to the UI element 500 or to the context of the UI generally.

By way of example without limitation, the UI element 500 may be a playback/pause button, and the other fingers 204, 206, and 208 might have additional UI elements such as fast forward, rewind, skip forward, skip back, volume control, etc. which are rendered when the other fingers 204, 206 and 208 are extended. However, when the fingers 204, 206, and 208 are curled as shown, then the additional UI elements are hidden and the additional information 502 is shown, which could include metadata such as a song title, artist, etc., for example.

Combining several principles of the present disclosure, in some implementations, a user may scroll various UI elements that are rendered along their fingers as described above, until a desired specific UI element is positioned along their index finger 202. And then for the specific UI element that is positioned along the user's index finger, then by curling the other fingers as shown, then additional information related to the specific UI element is surfaced. Such an interface can be utilized to enable the user to browse a listing of elements and surface additional related information for a given element. By way of example without limitation, such an interface mechanic could be utilized to access search results (e.g. web search or other contextual search results), where the search result listings are scrollable, and a given search result is further accessed by curling the fingers (e.g. surfacing the webpage of the given web search result).

The hand-based user interface of the present disclosure is applicable to AR, XR, and VR experiences, as has been noted. In the case of AR and XR, the user's physical hand is viewable, and the user interface is rendered on or in association with the view of the user's physical hand. However, in the case of the VR experience, the user's hand may be replaced with a virtual hand whose movements are controlled by the user's actual hand, and accordingly, the user interface can be rendered on or in association with the virtual hand that is rendered in the user's view.

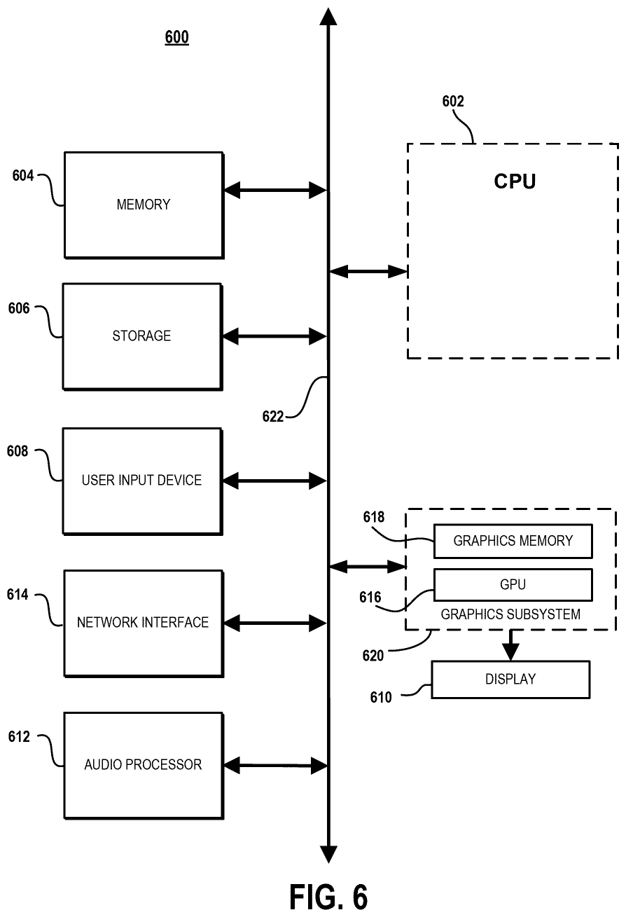

FIG. 6 illustrates components of an example device 600 that can be used to perform aspects of the various embodiments of the present disclosure. This block diagram illustrates a device 600 that can incorporate or can be a personal computer, video game console, personal digital assistant, a server or other digital device, suitable for practicing an embodiment of the disclosure. Device 600 includes a central processing unit (CPU) 602 for running software applications and optionally an operating system. CPU 602 may be comprised of one or more homogeneous or heterogeneous processing cores. For example, CPU 602 is one or more general-purpose microprocessors having one or more processing cores. Further embodiments can be implemented using one or more CPUs with microprocessor architectures specifically adapted for highly parallel and computationally intensive applications, such as processing operations of interpreting a query, identifying contextually relevant resources, and implementing and rendering the contextually relevant resources in a video game immediately. Device 600 may be a localized to a player playing a game segment (e.g., game console), or remote from the player (e.g., back-end server processor), or one of many servers using virtualization in a game cloud system for remote streaming of gameplay to clients.

Memory 604 stores applications and data for use by the CPU 602. Storage 606 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 608 communicate user inputs from one or more users to device 600, examples of which may include keyboards, mice, joysticks, touch pads, touch screens, still or video recorders/cameras, tracking devices for recognizing gestures, and/or microphones. Network interface 614 allows device 600 to communicate with other computer systems via an electronic communications network, and may include wired or wireless communication over local area networks and wide area networks such as the internet. An audio processor 612 is adapted to generate analog or digital audio output from instructions and/or data provided by the CPU 602, memory 604, and/or storage 606. The components of device 600, including CPU 602, memory 604, data storage 606, user input devices 608, network interface 610, and audio processor 612 are connected via one or more data buses 622.

A graphics subsystem 620 is further connected with data bus 622 and the components of the device 600. The graphics subsystem 620 includes a graphics processing unit (GPU) 616 and graphics memory 618. Graphics memory 618 includes a display memory (e.g., a frame buffer) used for storing pixel data for each pixel of an output image. Graphics memory 618 can be integrated in the same device as GPU 608, connected as a separate device with GPU 616, and/or implemented within memory 604. Pixel data can be provided to graphics memory 618 directly from the CPU 602. Alternatively, CPU 602 provides the GPU 616 with data and/or instructions defining the desired output images, from which the GPU 616 generates the pixel data of one or more output images. The data and/or instructions defining the desired output images can be stored in memory 604 and/or graphics memory 618. In an embodiment, the GPU 616 includes 3D rendering capabilities for generating pixel data for output images from instructions and data defining the geometry, lighting, shading, texturing, motion, and/or camera parameters for a scene. The GPU 616 can further include one or more programmable execution units capable of executing shader programs.

The graphics subsystem 614 periodically outputs pixel data for an image from graphics memory 618 to be displayed on display device 610. Display device 610 can be any device capable of displaying visual information in response to a signal from the device 600, including CRT, LCD, plasma, and OLED displays. Device 600 can provide the display device 610 with an analog or digital signal, for example.

It should be noted, that access services, such as providing access to games of the current embodiments, delivered over a wide geographical area often use cloud computing. Cloud computing is a style of computing in which dynamically scalable and often virtualized resources are provided as a service over the Internet. Users do not need to be an expert in the technology infrastructure in the “cloud” that supports them. Cloud computing can be divided into different services, such as Infrastructure as a Service (IaaS), Platform as a Service (PaaS), and Software as a Service (SaaS). Cloud computing services often provide common applications, such as video games, online that are accessed from a web browser, while the software and data are stored on the servers in the cloud. The term cloud is used as a metaphor for the Internet, based on how the Internet is depicted in computer network diagrams and is an abstraction for the complex infrastructure it conceals.

A game server may be used to perform the operations of the durational information platform for video game players, in some embodiments. Most video games played over the Internet operate via a connection to the game server. Typically, games use a dedicated server application that collects data from players and distributes it to other players. In other embodiments, the video game may be executed by a distributed game engine. In these embodiments, the distributed game engine may be executed on a plurality of processing entities (PEs) such that each PE executes a functional segment of a given game engine that the video game runs on. Each processing entity is seen by the game engine as simply a compute node. Game engines typically perform an array of functionally diverse operations to execute a video game application along with additional services that a user experiences. For example, game engines implement game logic, perform game calculations, physics, geometry transformations, rendering, lighting, shading, audio, as well as additional in-game or game-related services. Additional services may include, for example, messaging, social utilities, audio communication, game play replay functions, help function, etc. While game engines may sometimes be executed on an operating system virtualized by a hypervisor of a particular server, in other embodiments, the game engine itself is distributed among a plurality of processing entities, each of which may reside on different server units of a data center.

According to this embodiment, the respective processing entities for performing the operations may be a server unit, a virtual machine, or a container, depending on the needs of each game engine segment. For example, if a game engine segment is responsible for camera transformations, that particular game engine segment may be provisioned with a virtual machine associated with a graphics processing unit (GPU) since it will be doing a large number of relatively simple mathematical operations (e.g., matrix transformations). Other game engine segments that require fewer but more complex operations may be provisioned with a processing entity associated with one or more higher power central processing units (CPUs).

By distributing the game engine, the game engine is provided with elastic computing properties that are not bound by the capabilities of a physical server unit.

Instead, the game engine, when needed, is provisioned with more or fewer compute nodes to meet the demands of the video game. From the perspective of the video game and a video game player, the game engine being distributed across multiple compute nodes is indistinguishable from a non-distributed game engine executed on a single processing entity, because a game engine manager or supervisor distributes the workload and integrates the results seamlessly to provide video game output components for the end user.

Users access the remote services with client devices, which include at least a CPU, a display and I/O. The client device can be a PC, a mobile phone, a netbook, a PDA, etc. In one embodiment, the network executing on the game server recognizes the type of device used by the client and adjusts the communication method employed. In other cases, client devices use a standard communications method, such as html, to access the application on the game server over the internet. It should be appreciated that a given video game or gaming application may be developed for a specific platform and a specific associated controller device. However, when such a game is made available via a game cloud system as presented herein, the user may be accessing the video game with a different controller device. For example, a game might have been developed for a game console and its associated controller, whereas the user might be accessing a cloud-based version of the game from a personal computer utilizing a keyboard and mouse. In such a scenario, the input parameter configuration can define a mapping from inputs which can be generated by the user's available controller device (in this case, a keyboard and mouse) to inputs which are acceptable for the execution of the video game.

In another example, a user may access the cloud gaming system via a tablet computing device, a touchscreen smartphone, or other touchscreen driven device. In this case, the client device and the controller device are integrated together in the same device, with inputs being provided by way of detected touchscreen inputs/gestures. For such a device, the input parameter configuration may define particular touchscreen inputs corresponding to game inputs for the video game. For example, buttons, a directional pad, or other types of input elements might be displayed or overlaid during running of the video game to indicate locations on the touchscreen that the user can touch to generate a game input. Gestures such as swipes in particular directions or specific touch motions may also be detected as game inputs. In one embodiment, a tutorial can be provided to the user indicating how to provide input via the touchscreen for gameplay, e.g., prior to beginning gameplay of the video game, so as to acclimate the user to the operation of the controls on the touchscreen.

In some embodiments, the client device serves as the connection point for a controller device. That is, the controller device communicates via a wireless or wired connection with the client device to transmit inputs from the controller device to the client device. The client device may in turn process these inputs and then transmit input data to the cloud game server via a network (e.g., accessed via a local networking device such as a router). However, in other embodiments, the controller can itself be a networked device, with the ability to communicate inputs directly via the network to the cloud game server, without being required to communicate such inputs through the client device first. For example, the controller might connect to a local networking device (such as the aforementioned router) to send to and receive data from the cloud game server. Thus, while the client device may still be required to receive video output from the cloud-based video game and render it on a local display, input latency can be reduced by allowing the controller to send inputs directly over the network to the cloud game server, bypassing the client device.

In one embodiment, a networked controller and client device can be configured to send certain types of inputs directly from the controller to the cloud game server, and other types of inputs via the client device. For example, inputs whose detection does not depend on any additional hardware or processing apart from the controller itself can be sent directly from the controller to the cloud game server via the network, bypassing the client device. Such inputs may include button inputs, joystick inputs, embedded motion detection inputs (e.g., accelerometer, magnetometer, gyroscope), etc. However, inputs that utilize additional hardware or require processing by the client device can be sent by the client device to the cloud game server. These might include captured video or audio from the game environment that may be processed by the client device before sending to the cloud game server. Additionally, inputs from motion detection hardware of the controller might be processed by the client device in conjunction with captured video to detect the position and motion of the controller, which would subsequently be communicated by the client device to the cloud game server. It should be appreciated that the controller device in accordance with various embodiments may also receive data (e.g., feedback data) from the client device or directly from the cloud gaming server.

In one embodiment, the various technical examples can be implemented using a virtual environment via a head-mounted display (HMD). An HMD may also be referred to as a virtual reality (VR) headset. As used herein, the term “virtual reality” (VR) generally refers to user interaction with a virtual space/environment that involves viewing the virtual space through an HMD (or VR headset) in a manner that is responsive in real-time to the movements of the HMD (as controlled by the user) to provide the sensation to the user of being in the virtual space or metaverse. For example, the user may see a three-dimensional (3D) view of the virtual space when facing in a given direction, and when the user turns to a side and thereby turns the HMD likewise, then the view to that side in the virtual space is rendered on the HMD. An HMD can be worn in a manner similar to glasses, goggles, or a helmet, and is configured to display a video game or other metaverse content to the user. The HMD can provide a very immersive experience to the user by virtue of its provision of display mechanisms in close proximity to the user's eyes. Thus, the HMD can provide display regions to each of the user's eyes which occupy large portions or even the entirety of the field of view of the user, and may also provide viewing with three-dimensional depth and perspective.

In one embodiment, the HMD may include a gaze tracking camera that is configured to capture images of the eyes of the user while the user interacts with the VR scenes. The gaze information captured by the gaze tracking camera(s) may include information related to the gaze direction of the user and the specific virtual objects and content items in the VR scene that the user is focused on or is interested in interacting with. Accordingly, based on the gaze direction of the user, the system may detect specific virtual objects and content items that may be of potential focus to the user where the user has an interest in interacting and engaging with, e.g., game characters, game objects, game items, etc.

In some embodiments, the HMD may include an externally facing camera(s) that is configured to capture images of the real-world space of the user such as the body movements of the user and any real-world objects that may be located in the real-world space. In some embodiments, the images captured by the externally facing camera can be analyzed to determine the location/orientation of the real-world objects relative to the HMD. Using the known location/orientation of the HMD the real-world objects, and inertial sensor data from the, the gestures and movements of the user can be continuously monitored and tracked during the user's interaction with the VR scenes. For example, while interacting with the scenes in the game, the user may make various gestures such as pointing and walking toward a particular content item in the scene. In one embodiment, the gestures can be tracked and processed by the system to generate a prediction of interaction with the particular content item in the game scene. In some embodiments, machine learning may be used to facilitate or assist in said prediction.

During HMD use, various kinds of single-handed, as well as two-handed controllers can be used. In some implementations, the controllers themselves can be tracked by tracking lights included in the controllers, or tracking of shapes, sensors, and inertial data associated with the controllers. Using these various types of controllers, or even simply hand gestures that are made and captured by one or more cameras, it is possible to interface, control, maneuver, interact with, and participate in the virtual reality environment or metaverse rendered on an HMD. In some cases, the HMD can be wirelessly connected to a cloud computing and gaming system over a network. In one embodiment, the cloud computing and gaming system maintains and executes the video game being played by the user. In some embodiments, the cloud computing and gaming system is configured to receive inputs from the HMD and the interface objects over the network. The cloud computing and gaming system is configured to process the inputs to affect the game state of the executing video game. The output from the executing video game, such as video data, audio data, and haptic feedback data, is transmitted to the HMD and the interface objects. In other implementations, the HMD may communicate with the cloud computing and gaming system wirelessly through alternative mechanisms or channels such as a cellular network.

Additionally, though implementations in the present disclosure may be described with reference to a head-mounted display, it will be appreciated that in other implementations, non-head mounted displays may be substituted, including without limitation, portable device screens (e.g. tablet, smartphone, laptop, etc.) or any other type of display that can be configured to render video and/or provide for display of an interactive scene or virtual environment in accordance with the present implementations. It should be understood that the various embodiments defined herein may be combined or assembled into specific implementations using the various features disclosed herein. Thus, the examples provided are just some possible examples, without limitation to the various implementations that are possible by combining the various elements to define many more implementations. In some examples, some implementations may include fewer elements, without departing from the spirit of the disclosed or equivalent implementations.

Embodiments of the present disclosure may be practiced with various computer system configurations including hand-held devices, microprocessor systems, microprocessor-based or programmable consumer electronics, minicomputers, mainframe computers and the like. Embodiments of the present disclosure can also be practiced in distributed computing environments where tasks are performed by remote processing devices that are linked through a wire-based or wireless network.

Although the method operations were described in a specific order, it should be understood that other housekeeping operations may be performed in between operations, or operations may be adjusted so that they occur at slightly different times or may be distributed in a system which allows the occurrence of the processing operations at various intervals associated with the processing, as long as the processing of the telemetry and game state data for generating modified game states and are performed in the desired way.

One or more embodiments can also be fabricated as computer readable code on a computer readable medium. The computer readable medium is any data storage device that can store data, which can be thereafter be read by a computer system. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can include computer readable tangible medium distributed over a network-coupled computer system so that the computer readable code is stored and executed in a distributed fashion.

In one embodiment, the video game is executed either locally on a gaming machine, a personal computer, or on a server. In some cases, the video game is executed by one or more servers of a data center. When the video game is executed, some instances of the video game may be a simulation of the video game. For example, the video game may be executed by an environment or server that generates a simulation of the video game. The simulation, on some embodiments, is an instance of the video game. In other embodiments, the simulation maybe produced by an emulator. In either case, if the video game is represented as a simulation, that simulation is capable of being executed to render interactive content that can be interactively streamed, executed, and/or controlled by user input.

Although the foregoing embodiments have been described in some detail for purposes of clarity of understanding, it will be apparent that certain changes and modifications can be practiced within the scope of the appended claims. Accordingly, the present embodiments are to be considered as illustrative and not restrictive, and the embodiments are not to be limited to the details given herein, but may be modified within the scope and equivalents of the appended claims.

1. A method for providing a user interface through a head-mounted display worn by a user, comprising:
identifying and tracking a hand of the user, including identifying and tracking a thumb and a fingertip of the hand of the user;
providing a real-time view of the user's hand through the head-mounted display;
rendering a graphical user interface (UI) element in association with a fingertip of the user's hand in the real-time view of the hand through the head-mounted display;
wherein detection of touching of the thumb to the fingertip activates selection of the graphical UI element to trigger an action associated with the graphical UI element.

2. The method of claim 1, wherein the graphical UI element is rendered as an overlay on the fingertip of the user's hand.

3. The method of claim 1, wherein the rendering of the graphical UI element is configured to track movements of the fingertip to maintain positioning of the graphical UI element in association with the fingertip.

4. The method of claim 1, wherein rendering the graphical UI element is in response to detecting viewing by the user of the hand.

5. The method of claim 1, wherein rendering the graphical UI element is in response to detecting the user's hand in an open-hand pose with a palm side of the hand facing the user.

6. The method of claim 1, wherein identifying and tracking the user's hand includes capturing images of the user's hand by a camera integrated with the head-mounted display.

7. The method of claim 1, wherein activating selection of the graphical UI element triggers rendering of a graphical slider element configured to enable adjustment of a setting by the thumb of the user's hand.

8. A method for providing a user interface through a head-mounted display worn by a user, comprising:
identifying and tracking a hand of the user, including identifying and tracking a thumb and fingertips of the hand of the user;
providing a real-time view of the user's hand through the head-mounted display;
rendering a plurality of graphical user interface (UI) elements in respective association with the fingertips of the user's hand in the real-time view of the hand through the head-mounted display;
wherein detection of touching of the thumb to a given fingertip activates selection of the graphical UI element associated with the given fingertip to trigger an action associated with the graphical UI element.

9. The method of claim 8, wherein the plurality of graphical UI elements are rendered as overlays on the respective fingertips of the user's hand.

10. The method of claim 8, wherein the rendering of the graphical UI elements is configured to track movements of the fingertips to maintain positioning of the graphical UI elements in respective association with the fingertips.

11. The method of claim 8, wherein rendering the graphical UI elements is in response to detecting viewing by the user of the hand.

12. The method of claim 8, wherein rendering the graphical UI elements is in response to detecting the user's hand in an open-hand pose with a palm side of the hand facing the user.

13. The method of claim 8, wherein identifying and tracking the user's hand includes capturing images of the user's hand by a camera integrated with the head-mounted display.

14. The method of claim 8, wherein detection of swiping of the thumb across fingers of the user's hand triggers scrolling of the graphical UI elements.

15. A non-transitory computer-readable medium having program instructions embodied thereon that, when executed by at least one computing device, cause said at least one computing device to perform a method for providing a user interface through a head-mounted display worn by a user, said method including:
identifying and tracking a hand of the user, including identifying and tracking a thumb and a fingertip of the hand of the user;
providing a real-time view of the user's hand through the head-mounted display;
rendering a graphical user interface (UI) element in association with a fingertip of the user's hand in the real-time view of the hand through the head-mounted display;
wherein detection of touching of the thumb to the fingertip activates selection of the graphical UI element to trigger an action associated with the graphical UI element.

16. The non-transitory computer-readable medium of claim 15, wherein the graphical UI element is rendered as an overlay on the fingertip of the user's hand.

17. The non-transitory computer-readable medium of claim 15, wherein the rendering of the graphical UI element is configured to track movements of the fingertip to maintain positioning of the graphical UI element in association with the fingertip.

18. The non-transitory computer-readable medium of claim 15, wherein rendering the graphical UI element is in response to detecting viewing by the user of the hand.

19. The non-transitory computer-readable medium of claim 15, wherein rendering the graphical UI element is in response to detecting the user's hand in an open-hand pose with a palm side of the hand facing the user.

20. The non-transitory computer-readable medium of claim 15, wherein identifying and tracking the user's hand includes capturing images of the user's hand by a camera integrated with the head-mounted display.
